(19) United States
(12) Patent Application Publication
(10) Pub. No.: US 2005/0060644 A1
(43) Pub. Date: Mar. 17, 2005

(54) Real time variable digital paper

(76) Inventor: John Douglas Patterson, Dayton, OH (US)

Correspondence Address: DINSMORE & SHOHL LLP;One Dayton Centre, Suite 1300, One South Main Street, Dayton, OH, 45402-2023, US

(21) Appl. No.: 10/925,533

(22) Filed: Aug. 25, 2004

Related U.S. Application Data
(60) Provisional application No. 60/503,182, filed on Sep. 15, 2003.

(51) Int. Cl. G06F 17/00

(52) U.S. Cl. 715/505

(57) ABSTRACT

Systems and methods to convert natural input to digital information by providing variable print on demand digital paper are disclosed. The systems and methods combine form design, a digital print shop, the capture of natural input, and the interpretation and validation of the digital representation of the captured natural input to provide a robust system that can be used to populate databases as well as feed workflow and back end processes. The form design combines custom templates with field definitions and variable data overlays that are merged with position coded patterns to print unique instances of digital forms such that each instance of a document occupies a coordinate space mutually exclusive with respect to the position code coordinate space of all other documents. The interpretation, recognition and validation programs combine to create an effective conversion of handwritten information to computer recognizable meaningful format.

### CROSS-REFERENCE TO RELATED APPLICATIONS

This application claims the benefit of U.S. Provisional Application Ser. No. 60/503,182, filed Sep. 15, 2003.

### BACKGROUND OF THE INVENTION

The present invention generally relates to the integration of handwritten, paper-based information with digital processes and, in particular, relates to systems and methods for capturing, processing, interpreting and verifying handwritten information using digitally capable writing implements.

The ability to capture and share information digitally continues to alter greatly the way people communicate. To this end, personal computers and the Internet have become ubiquitous and now permeate the lives of many people on both a business and personal level. In addition, cellular and other wireless telephony technologies are increasingly adding to the capability and the diversity of ways that digital information can be transferred.

Despite the efficiencies provided by the various digital technologies, natural input, such as handwriting information on traditional paper, is still relied upon. Natural input has the advantage that it does not require people to learn how to operate computers and other electronic devices, as well as that it has no impediments as to when or where the information is recorded. For example, a writer choosing ordinary paper as the desired medium to record information is not encumbered by a large and bulky computer and is not constrained to the physical location of the computer. In some instances, information handwritten on a piece of paper serves as the only record of that information. For example, doctors routinely handwrite prescriptions on their prescription pad and give that prescription directly to a patient. The patient then delivers the prescription directly to a pharmacist who provides the necessary medications. Countless other applications exist where paper is relied upon for conveying and storing information. Therefore, it would be unimaginable to think the traditional paper would become an outdated dispensable method of communicating information.

At this time, many computer systems are simply not capable of adequately understanding natural input formats. For example, in order to transfer handwritten information into a meaningful format on a computer system, a user must convert the handwriting into a digital format. This is typically done by scanning the handwritten document. Then the user must inspect the scanned document and validate the accuracy of the results of the digital conversion of the handwriting. Currently, the available computer conversion tools are slow and produce inconsistent results.

Recently, Anoto AB of Stockholm, Sweden developed a new technique for digitally capturing handwritten information. Anoto's technique derives a large virtual position code, referred to generally as the Anoto pattern. A subset of the Anoto pattern is printed on the face of a sheet of ordinary paper. A writing implement equipped to read the position code, referred to generally as a digital pen, is used to write on the position-coded paper. The digital pen reads the position codes encountered by the digital pen and either stores or transmits the position data to a computer. By reconstructing the positions visited by the digital pen, a representation of the information handwritten on the position-coded paper can be created and stored as a digital data and image file. The use of a digital pen and position-coded paper eliminates the need to separately scan a piece of ordinary paper to transfer the information written on it into a digital format.

However, a need exists for delivering the position-coded paper as variable print-on-demand format. An additional need exists for improving the ability of computer systems to transform the digital representation of the handwritten information recorded by a digital pen into reliable and verified digital content.

### BRIEF SUMMARY OF THE INVENTION

The present invention overcomes the disadvantages of current methods and systems of converting natural input to meaningful digital information by providing variable print on demand digital paper systems and methods.

The systems and methods herein combine form design, a digital print shop, the capture of natural input, and the interpretation and validation of the digital representation of the captured natural input to provide a robust system that can be used to populate databases as well as feed workflow and back end processes. The form design is capable of combining custom templates with field definitions for the template and variable data overlays that can be merged with position coded patterns to print, on demand, unique instances of digital forms such that each instance of any document occupies a coordinate space that is mutually exclusive with respect to the position code coordinate space of all other documents. The digital forms information is handwritten on the digital form using a digital input device such as a digital pen. The handwritten information captured by the digital input device is then transferred to a computer system where the correlation, the interpretation, recognition and validation programs combine to create an effective conversion of the handwritten information to a computer recognizable meaningful format. Other objects of the present invention will be apparent in light of the description of the invention embodied herein.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals, and in which:

FIG. 1 is a schematic representation of a print on demand system for creating digital forms according to an embodiment of the present invention;

FIG. 2 is a schematic representation illustrating some of the ways in which a digital pen can communicate with a computer system according to an embodiment of the present invention;

FIG. 3 is a schematic representation of a print on demand system for creating digital forms according to another embodiment of the present invention;

FIG. 4 is an illustration of a print dialog box used to print a position code onto ordinary paper according to an embodiment of the present invention;

FIG. 5 is a schematic representation of a virtual position code coordinate space illustrating an exemplary way to assign a subset of the coordinate space to an instance of a digital form according to an embodiment of the present invention;

FIG. 6 is a schematic representation of a system for interpreting, recognizing and validating representations of handwriting obtained from digital input devices according to an embodiment of the present invention;

FIG. 7 is a flow chart illustrating a method of transforming representations of handwritten information into computer recognizable text according to an embodiment of the present invention;

FIG. 8 is a flow chart illustrating a method of for interpreting and recognizing representations of handwriting obtained from digital input devices according to an embodiment of the present invention;

FIG. 9 is a flow chart illustrating a method of for validating interpreted representations of handwriting obtained from digital input devices according to an embodiment of the present invention;

FIG. 10A is an illustration of a computer screen shot illustrating various validation and interpretation techniques according to an embodiment of the present invention;

FIG. 10B is another illustration of a computer screen shot illustrating various validation and interpretation techniques according to an embodiment of the present invention;

FIG. 11A is an illustration of an exemplary application where digital pens are used to hand write information onto a digital form having a position code thereon, according to an embodiment of the present invention; and

FIG. 11B is an illustration of the digital form of FIG. 11A after performing interpretation, recognition and validation techniques to convert the handwritten information into computer recognizable text according to an embodiment of the present invention.

### DETAILED DESCRIPTION

In the following detailed description of the preferred embodiments, reference is made to the accompanying drawings that form a part hereof, and in which are shown by way of illustration, and not by way of limitation, specific preferred embodiments in which the invention may be practiced. It is to be understood that other embodiments may be utilized and that logical, mechanical and electrical changes may be made without departing from the spirit and scope of the present invention.

### Digital Paper

In order to facilitate the efficient tracking and storage of naturally recorded information, various embodiments of the present invention take advantage of the flexibility of “digital paper.” Digital paper provides a surface upon which position code is applied. The position code essentially overlays a two dimensional coordinate space on the surface of the paper such that each set of coordinates can be unambiguously identified. A digital input device is used to read the coordinates of the position code to track the handwritten information. The term “digital paper” as used herein is not limited to paper based products, however. Rather, digital paper as used herein, refers to any surface upon which a position code can be printed or otherwise situated such as, for example, a white board or an easel board.

Any unambiguous pattern can be used to define the position code, printed or otherwise applied to a surface, so long as a corresponding digital input device is provided capable of reading the position code. For example, one position coding technique suitable for use herein is known generally as the Anoto pattern. The Anoto pattern consists of small dots that are slightly displaced from a grid structure in a manner that forms a pattern. For example, one current implementation of the Anoto pattern constructs a pattern defined by thirty six dots that are each one-tenth of a millimeter in diameter, arrayed on a square grid that is approximately 2×2 millimeters. By displacing the dots with respect to X and Y axes, over 4×10²¹ possible square combinations can be derived. The Anoto pattern conceptually consists of a coordinate space map where each square combination is represented only once. This arrangement results in a map of dots covering approximately 1.8 million square miles. In practice, each sheet of “digital paper” carries only a small portion of the Anoto pattern, which appears as a light gray dusting on the surface of the paper. The Anoto pattern is the subject of a number of U.S. patents, including for example, U.S. Pat. No. 6,502,756, issued Jan. 7, 2003.

### Digital Pen

In order to decipher the position code on the surface of a piece of digital paper, a digital input device, referred to generally as a digital pen, is used to read the map of dots. Commonly available digital pens are slightly larger than ordinary pens, but otherwise are very similar in appearance thereto. Typical digital pens include a scanning device comprising an infrared camera and an imaging processing system. A writing implement, such as an ink tip, is typically positioned proximate to the scanning device to provide visual feedback to the user so that a physical ink mark is left on the paper as the user writes thereupon. After the digital pen presses against a surface containing an appropriate position code pattern, the pen begins to take a series of snapshots of the position code at a given rate, often more that 50 snapshots per second, until the digital pen is lifted from the surface. Every snapshot read by the digital pen contains sufficient information to calculate the exact position of the digital pen on the unambiguous position code.

The digital pen may also include a memory device for recording the position codes read by the digital pen. This type of digital pen communicates with a computer system when it is docked in a docking station or cradle designed to extract the information from the digital pen and transfer it to the computer system. The digital pen may also contain a plug that transfers the information when connected by an USB cable to an USB port of the computer system. Digital pens may also be equipped with a wireless transmitter. For example, digital pens are currently available that utilize the 802.11 family or Bluetooth wireless technology to transmit either directly to a computer system or cellular device, or to an intermediate system that conveys the information from the digital pen forward to the computer system or cellular device.

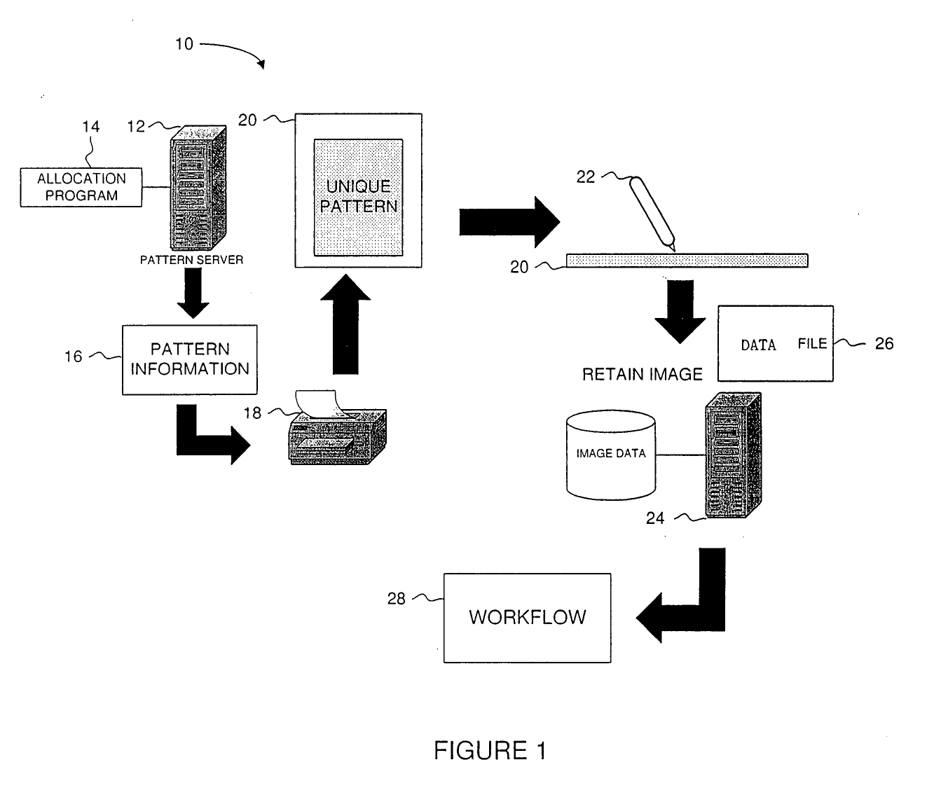

FIG. 1 illustrates diagrammatically a variable print on demand system 10 that takes advantage of the position coding on paper products and is capable of enhanced integration of handwritten information with digital processes to direct work flow. A pattern server 12, also referred to herein as an allocation server, is used to assign a position code to a document. The position code can comprise any unambiguous pattern information, such as the Anoto pattern devised by Anoto AB of Stockholm Sweden.

The pattern server 12 can be any computer system, including a desktop office computer, that is capable of executing an allocation program 14. The allocation program 14 assigns a minute subset of the entire coordinate space of the position code to any particular document. The document may comprise, for example, a blank piece of paper; a collection of blank pieces of paper such as, for example, a book or a brochure; or a preprinted form. The allocation program 14 also keeps track of the subset of the position code assigned to each particular document or makes the position information available to other data sources. A separate program (not shown) on the pattern server 12 prepares the pattern information for printing by creating a postscript file 16 containing the pattern information. The postscript file 16 can then be printed onto ordinary paper using any suitable printer 18, such as a typical office laser printer or a high end production laser printer like a Xerox Docutech or HP Indigo. A piece of paper having the pattern information printed thereon is referred to herein as digital paper 20. Of course, if print-on-demand is not essential to the particular application, a remote document production facility can produce, print and distribute batches of paper that includes the appropriate position codes printed on the surface of the paper. The paper is then stored until needed.

A user may write information onto the digital paper 20 using a digital pen 22. The digital pen 22 reads the positions on the paper over which the pen point moves and transfers this information to a suitable computer system 24, where it is transferred to a service provider (ASP) or to an application running locally on a personal computer, local area network (LAN), wide-area network (WAN) or any web service provided through the Internet. The transferred information is processed (i.e., correlated to the original image and subjected to handwriting interpretation, verification, signature authentication and image creation) and stored on a device, such as, for example, a correlation server, for storage and subsequent processing. The computer system 24 may optionally be the same computer system that runs the pattern server 12. The position code information read by the digital pen 22 is saved in a data file 26 that comprises a series of digital coordinates found on the unique position code that represents where the handwritten information was written by the digital pen 22. Once the data file 26 has been transmitted to the correlation server and the digitally captured representation of handwriting is converted into data, the appropriate workflow 28 can be determined and implemented based upon the intended application. The workflow may comprise pushing or pulling upstream or downstream systems with data, populating databases, sending emails containing a copy of the digital form, sending email reminders based upon detected content in the digital form, or indexing images and related data for subsequent lookup.

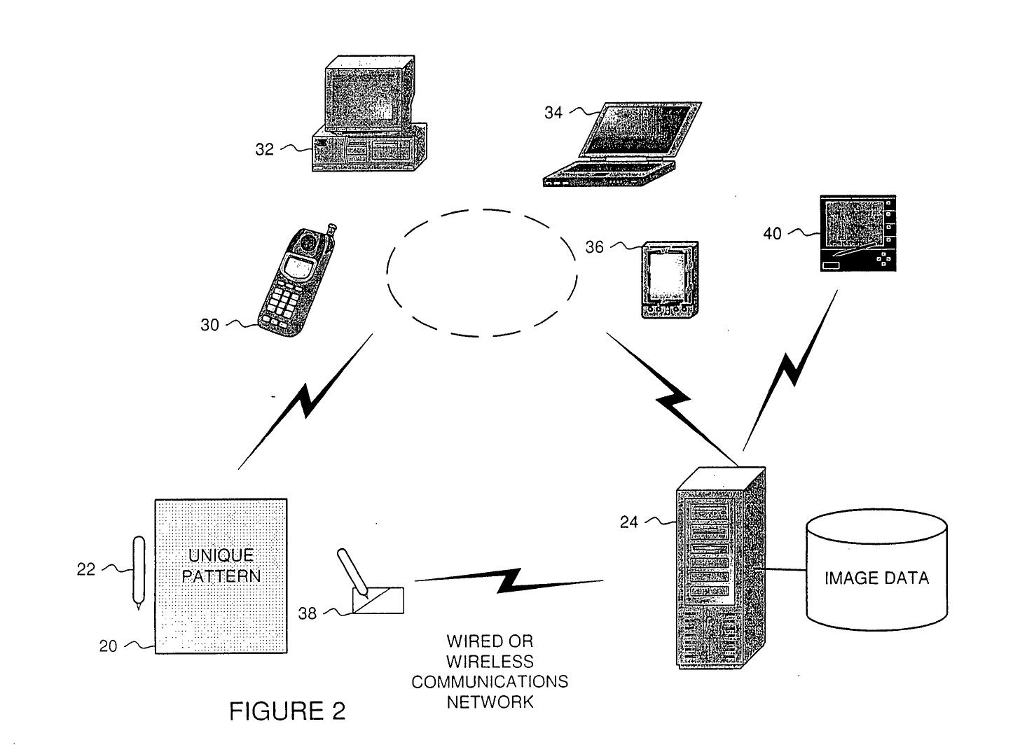

Referring to FIG. 2, any technology can be used to transmit the information recorded by the digital pen 22 to the computer system 24. For example, the digital pen 22 can transmit the information using a wireless technology to a wireless telephony device 30 such as, for example, a cellular telephone, a desktop computer 32, laptop computer 34 or personal digital assistant (PDA) 36, such as a Palm or Blackberry device, that is suitably equipped to receive the wireless transmission. Alternatively, the digital pen 22 may be equipped to transmit to an external device such as a docking station or cradle 38 that can communicate directly with the computer system 24. Further still, the digital pen 22 may be equipped with a plug that may connect the digital pen 22 to the computer system 24 via for example, an USB cable or FireWire to an USB or FireWire port of the computer system 24. The various embodiments of the present invention can also be integrated with data recorded on a tablet PC 40.

### Variable Print On Demand System

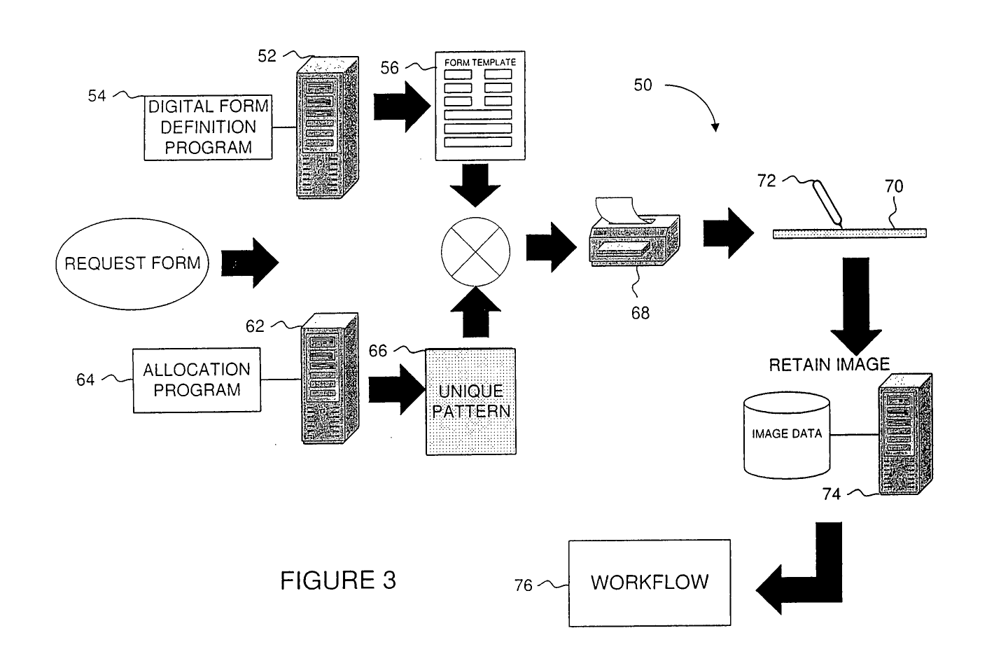

Referring to FIG. 3, the usability of the digital paper and pen technology can be enhanced by a system 50 that combines a template or form overlay with the digital paper technology. A request is issued to create a form. A first server 52 provides the appropriate combination of form templates and overlays, such as by using a suitable digital form definition program 54. The digital form definition program 54 provides tools to design the layout 56 of the physical form and can also be used to associate an overlay with an existing paper form. The form template comprises fields, text, graphics and any other indicia required by each instance of a desired form. The form template also allows for the creation of fields that are associated with definitions that are to be subsequently interpreted. For example, the form template may include deterministic fields such as check boxes, radial buttons and similar option fields. The digital form definition program may also optionally allow a user to assign types to fields on a particular form. For example, fields may be designated as signature fields, hand written input fields (e.g. date, state, zip code, quantity, alpha and or numeric), symbol fields and graphics fields. The assignment of field types allows back end software that interprets the fields to be customized to the specific field type as will be explained more fully below. The template can be saved and recalled to generate quickly several instances of the same form.

The overlay provides information from any suitable data source, such as a database that is to be merged with the particular instance of the digital form being created. This information obtained from the data source may comprise data that is unique to each instance of a form, or alternatively, the data obtained by the overlay for the form may comprise repetitive data. For example, the overlay may comprise variable information such as demographic or personal data from a database, sequential control numbers, date and time stamps or other types of information. The layout 56 can be generated and saved for example, in any printable format including the portable document format (PDF), or in any word processing format.

A second server 62 defines a pattern or allocation server such as the pattern server 12 described above with reference to FIG. 1. The second server 62 manages the complete digital print space and runs an allocation program 64 that assigns a position code comprised of a subset of the position code coordinate space to an instance of a form to be created. The unique position code pattern 66 assigned by the allocation program 64 is merged with the layout 56 created on the first server 52 and is printed using a suitable printer 68 to produce a digital form 70. The system 50 further preferably stores the unique position code pattern and the particular layout 56 associated with the unique position code pattern, together with a unique identifier, so that information regarding the particular instance of any digital form can be later retrieved and examined.

A user hand writes information onto the digital form 70 using a digital pen 72. The digital pen 72 reads the position information, and transfers a file, such as a data file, to a third server 74. The third server serves as a correlation server for storage and subsequent processing of the digital representation of the handwritten information recorded by the digital pen 70. Once the data file has been transmitted to the correlation server, the appropriate workflow 76 can be implemented based upon the intended application. The first, second and third servers 52, 62 and 74 can be implemented on the same or different physical computers.

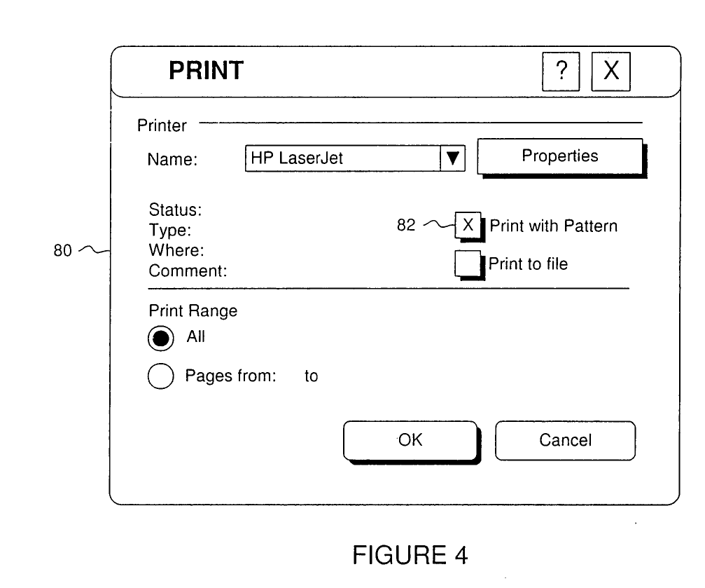

A dedicated layout program such as digital form definition software 54 is not required to practice the present invention. For example, referring to FIG. 4, if the layouts 56 are created using Word, Excel, PowerPoint slides, Engineering diagram, or other general software applications, then any computer user printing a layout 56 can optionally have an option available to them, within a customized print dialogue box 80, to print the particular instance of the form with a unique position code. For example, the print dialog box 80 may include a “Print with Pattern” checkbox option 82. Referring back to FIG. 3, any document printed with this option would be routed to the pattern allocation program 64 on the second server 62, which could be either on-site or provided as an ASP service by a commercial printing company.

The allocation program 64 then applies the unique position code pattern and overlay to the document, and optionally direct the printed output to the appropriate laser printer. For example, that printer could be the closest printer in proximity to the person requesting the document that is capable of the appropriate resolution to output the position code pattern. Of course, where print on demand is not required, the digital forms may be generated and printed at a commercial printer facility, with each instance of the digital form bearing a unique position coding pattern and the appropriate form overlay. As yet another alternative, part of the position code pattern and/or overlay may be preprinted, for example, by a commercial printer. A subsequent print on demand system then only needs to print the remainder of the position code and template or any additional position code and template, which can speed up the generation of the required digital forms.

### Identifying Unique Instances of Digital Forms

As pointed out above, the system 50 preferably stores the unique position code pattern and the particular layout 56 associated with that unique position code pattern together with a unique identifier so that information regarding the particular instance of any digital form can be later retrieved and examined. This unique identifier can comprise any unique key or other indexing scheme that allows a subsequently received data file to be properly and unambiguously associated with the correct layout 56.

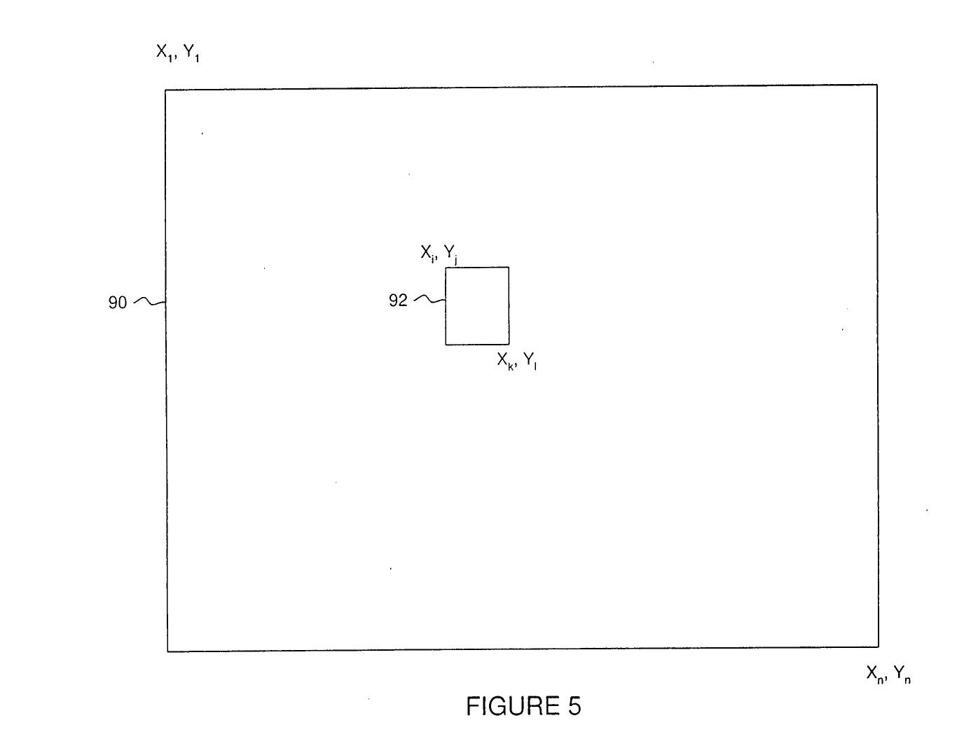

According to an embodiment of the present invention, each instance of a digital form is provided a unique position code, preferably in a contiguous coordinate range selected from a subset of the position code coordinate space such that the entire range of coordinates assigned to a particular instance of the form is mutually exclusive to the all other instances of all digital forms and other digital documents. For example, referring to FIG. 5, assume that the allocation program maps the range of coordinates for the entire position code space 90 across a two dimensional surface from X₁,Y₁ to Xₙ,Yₙ. Also assume that the allocation program assigns a given instance of a digital form 92 a position code that encompasses the coordinate space ranging from Xᵢ,Yⱼ to Xₖ,Yₗ. The allocation program will ensure that no other digital document is assigned a position code that has a coordinate space that intersects the range of Xᵢ,Yⱼ to Xₖ,Yₗ. Accordingly, there is no overlap in the coordinate space from one instance of a form to the next. This allows any particular document to be identified easily immediately simply by knowing any position code coordinate on the form.

Using the assignment of coordinate space described with reference to FIG. 5, the unique identifier for each instance of a digital form can be an expression of the subset of the coordinate space assigned to that form. For example, a unique identifier may be expressed in terms of the upper left hand corner coordinates to the lower right hand corner coordinates, e.g., Xᵢ,Yⱼ to Xₖ,Yₗ. Alternatively, the unique identifier may be expressed in terms of the upper left hand corner coordinates and the size of the digital form to be printed, e.g., Xᵢ,Yⱼ and 8½″×11″. Any single coordinate pair on a digital form that is read by a digital pen thus unambiguously belongs to only one previously assigned mutually exclusive subset of position code coordinates from the coordinate space and thus one particular instance of a digital form. This allows a simple search through the identifiers stored by the allocation server to associate that document with other digitally stored data related to that data. The coordinate pair read by the digital pen is compared against each stored identifier to see if that coordinate pair falls within the range of coordinate space bound by the identifier. If the coordinate pair read by the digital pen falls within a particular range, the digital document read by the digital pen is unambiguously associated with that identifier. As such, there is no need for the user to scan, mark, or otherwise acknowledge a unique control number or key on the digital form because the coordinate range of the form is the key or control identifier. However, if the digital form is created wirelessly or has a partially preprinted pattern, the user may need to scan, mark, or otherwise acknowledge a unique control number or key on the digital form.

The above discussion characterized the position code coordinate space in terms of a two dimensional map for purposes of clarity of discussion. The unique squares that define the pattern space can be arranged in any other space so long as there is a suitable and unambiguous way to map the unique square to a specific location on a particular instance of a digital form.

### Multiple Users and a Single Instance of a Digital Form

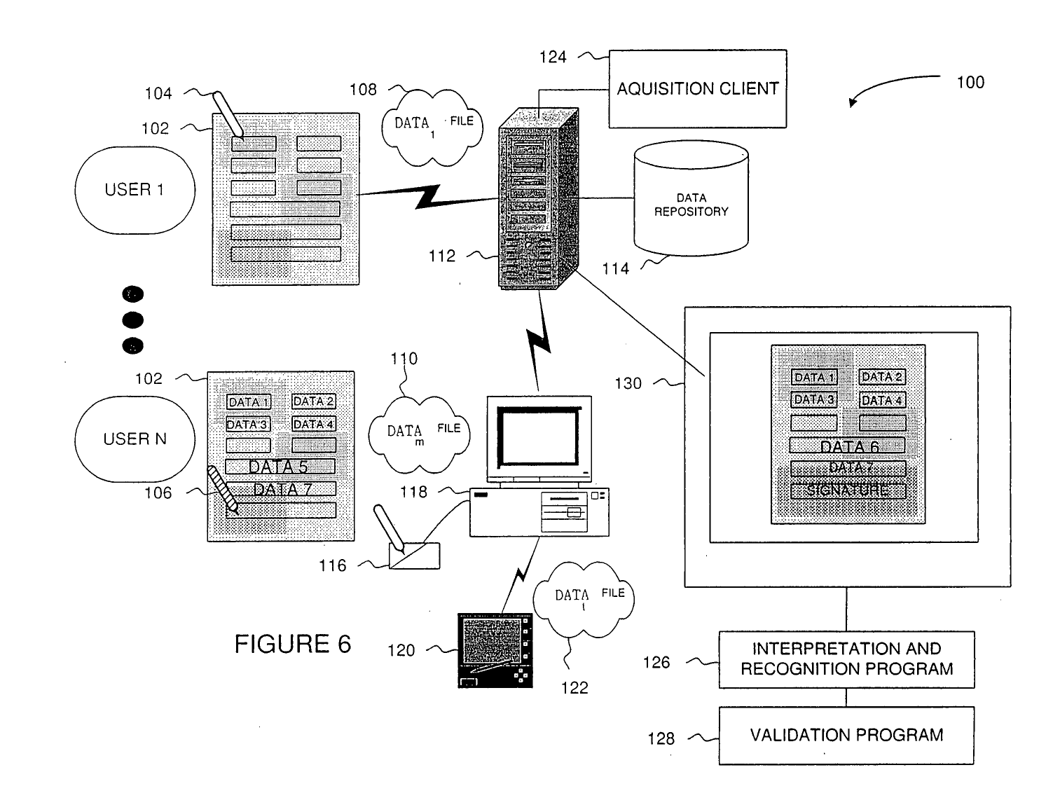

Referring to FIG. 6, a system 100 is provided for interpreting and validating information retrieved from digital forms. The system is configured to accommodate a single data file generated by a single digital pen, or several data files may be combined where each data file is associated with a select one of multiple digital pens that have written on the digital form. This allows multiple persons to collaborate in the editing of a document.

For example, user 1 provides handwritten information on a first part of the digital form 102 using a first digital pen 104. User N provides handwritten information on a second part of the digital form 102 using a second digital pen 106. Under such circumstances, each digital pen 104, 106 transmits a data file 108, 110 recorded thereby to an correlation server 112 and a corresponding data repository 114. For mere purposes of illustrating the flexibility of the present invention, the first digital pen 104 is schematically illustrated as transmitting its data file 108 via a wireless transmission and the second digital pen 106 is schematically illustrated as using a cradle 116 to transmit the data file 110 via an intermediary computer 118. It should also be pointed out that there need not be a direct one to one correspondence in the number of users and data files generated. For illustrative purposes, a total of N users have generated only M total data files. However, for the maximum flexibility in preserving an accurate history, it is preferable that each user use their own digital pen. As such, there would be a one to one correspondence between users and data files.

Also, because the layout of the digital form is known, a copy of the layout of the form can be electronically transferred into a tablet PC 120. A user of the tablet PC can see on the tablet PC 120, a digital representation of the form 102 and use a technology such as Microsoft Digital Ink by Microsoft Corporation of Redmond Wash. to create yet another data file 122 that is transmitted to the correlation server 112. In order to match properly the data file 122 from a tablet PC 120 with the corresponding digital form 102, the tablet PC 120 will also need to know the unique identifier of the digital form 102.

Preferably, each digital pen 104, 106 used to handwrite upon the digital form 102, and the tablet PC 120 used to create a data file provides an identifier that associates a particular digital pen or tablet PC with an associated data file. Moreover, the first and second digital pens 104, 106 and tablet PC 120 are preferably capable of providing a time stamp to their associated data files so that a chronological history can be constructed to determine exactly when a handwriting was applied to the document.

The correlation server 112 comprises a program, such as an acquisition client 124 that collects the data files 108, 110, 122 created from the various digital pens 104, 106 and tablet PC 120, and stores the associated files in the data repository 114 along with any other useful information that can be obtained, such as the digital pen identifier associated with each data file, and a date and time stamp associated with each data file. The data files and other collected data may also be matched up and stored together with the unique identifier, form layout and other previously gathered information concerning the specific instance of the digital form 102.

### Interpreting and Validating Information Retrieved From Digital Forms

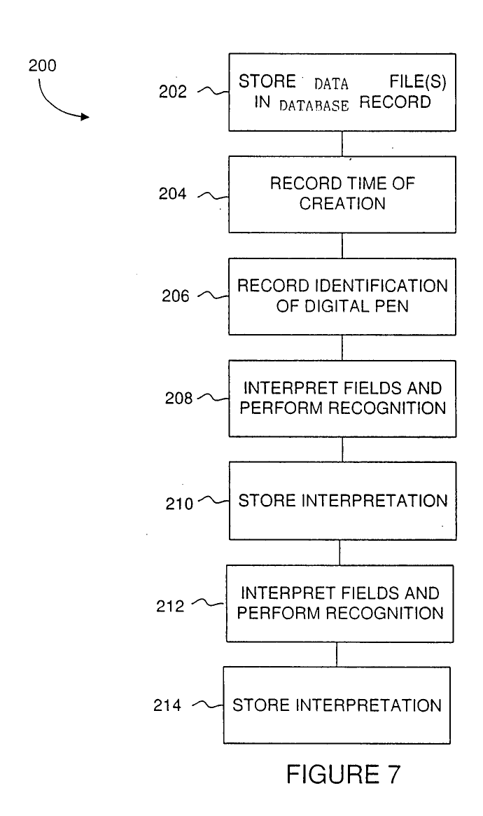

Referring to FIG. 7, the process 200 for merging the data files to a particular instance of a digital form includes storing the data files generated by digital pens and tablet PCs in a database at 202. The time of creation of the data in each data file is stored in the database at 204, and the identifier of the digital pen, tablet PC, or wireless device such as, for example, a cellular telephone that generated each data file is stored in the database at 206. Interpretations and recognitions are then performed on the representations of handwriting stored in the data file(s) at 208, and the generated interpretations are stored at 210. Validation (checking for accuracy of the interpretation) of the interpretation and recognition is performed at 212, and the results of the validation are stored at 214. Note that a complete history can be reconstructed because the interpretations did not overwrite or modify the original data files themselves.

It is helpful to know a priori, as much about the types of information expected to be written on the digital form as possible. If the digital form was created using the digital form definition program 54 described with reference to FIG. 3 or a similar program, information about the types of defined fields is saved with the template file, which is helpful for improving the efficiency and accuracy of the interpretation processes herein. Once the appropriate information has been retrieved, including the field definitions of the form template where available, the interpretation process is carried out.

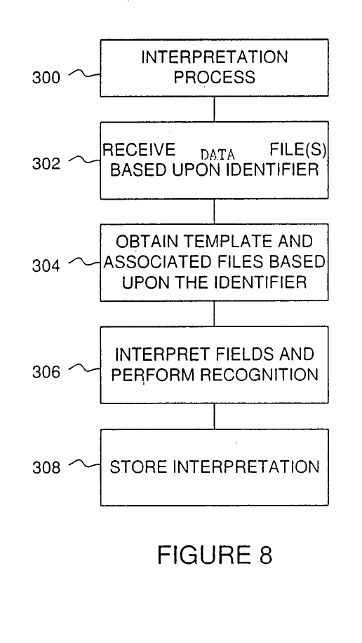

Referring to FIG. 8, the interpretation process 300 is initiated, and the necessary data files are obtained at 302. The template and other files associated with the unique instance of the digital form are also retrieved at 304. The system then uses various forms of character recognition to interpret or recognize the representations of handwritten data extracted from the data files at 306. Once the system has completed this process, the interpreted results are stored at 308 for subsequent processing.

Referring back to FIG. 6, the system 100 includes an interpretation and recognition program 126 to interpret the data files 108, 110, 122 associated with the unique instance of the digital form 102. The interpretation process is a first pass that attempts to transform the representations of handwritten information in the associated data files into computer compatible formats. For example, character recognition of the data file(s) is carried out. Where field definitions of the template file are available, character recognition can be carried out with a relatively high rate of precision, especially for the deterministic fields because the character recognition software already knows the type of data expected in a particular location. By applying handwriting recognition software technology, data elements can be captured from the document and used to feed down stream systems, to populate a database or to index the image for subsequent look-up.

The interpretation program 126 thus essentially hypothesizes the actual field values and other information recorded by the data file(s). The interpretation program 126 can take advantage of handwriting recognition software for decoding the handwritten information. However, the interpretation program may also further include specialized programs, such as dedicated signature recognition and analysis program for analyzing signature fields. The signature recognition program can comprise a specialized set of analysis tools useful for signature recognition. The signature recognition program not only converts the signature to text, but also further provides tools to detect fraud by attempting to authenticate the signature to establish that the person who signed the digital form is really who that person purports to be. Moreover, other specialized recognition programs can include a symbol module for deciphering symbols and graphics, such as those used to mark deterministic fields such as check boxes as well as handwritten scrawls such as cross-outs, carat insertions, deletions, additions, or any other editorial marks used to indicate changes to the handwritten information.

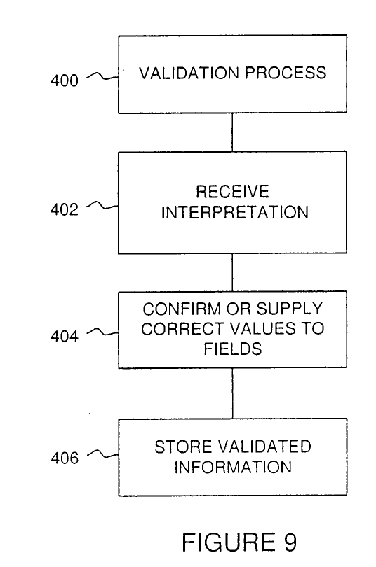

Referring to FIG. 9, once the computer system has completed the interpretation and recognition phase, a validation process is provided to allow for the correction of data that was misinterpreted during interpretation. The validation process 400 receives the interpretation of the data files at 402. If a field is critical, the validation process 400 may require a proactive confirmation at 404. Otherwise, the validation process 400 prompts the user to supply correct values to misinterpreted fields at 404. The validated information is stored at 406. The validation process may be completed numerous times and by more than one person. The user of the validation process does not need to be the author.

Referring back to FIG. 6, upon completion of any desired character recognition and conversion, the converted text is made available for authentication. For example, using a secure Internet connection, the author of a data file can log into the computer system using a web browser and view the results of the conversion. According to one embodiment of the present invention, a validation program 128 duplicates the specific instance of the digital form back to the authorized user via the web page. The data file is displayed on a computer screen 130 in a format that shows the strokes made on the form by the author(s) in a grayed out format with the converted text displayed adjacent the appropriate portions of the data file. If part of the conversion is incorrect, the author, or authorized user can use his browser to click on the appropriate field and correct the interpretation. In another embodiment, the validation program functions similar to a word processing spell checker, presenting the most closely matching words as well as the option of keying in the correct interpretation.

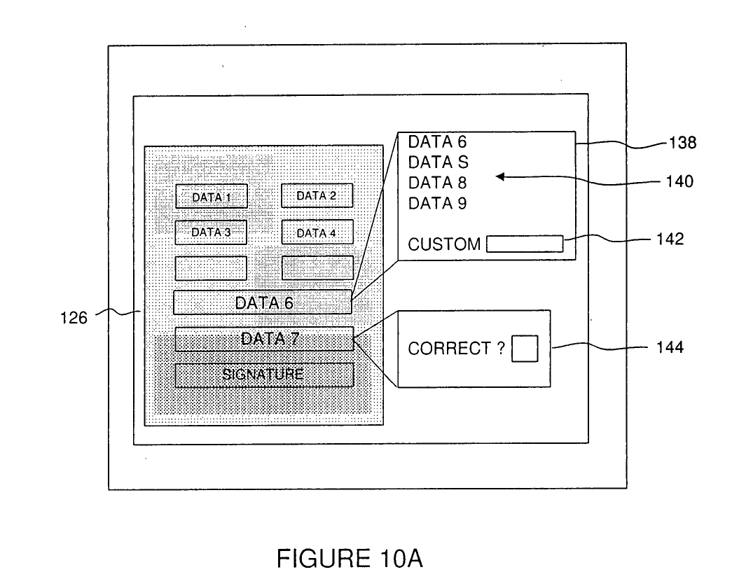

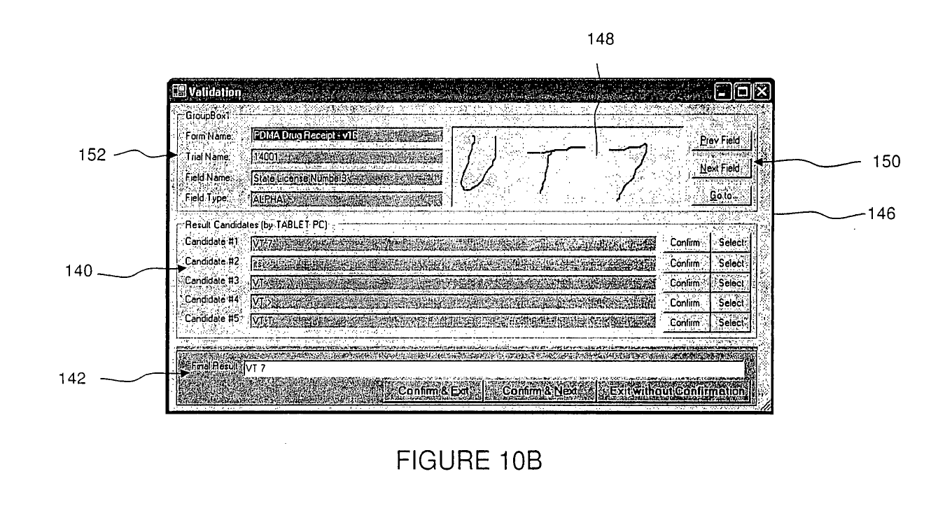

For exemplary purposes, it can be seen that the recognition program displays on the computer screen 130 a field having the value DATA 6. However, as can be seen on the instance of the digital form adjacent to user N, the correct value should be DATA 5. As such, a user can correct the misinterpreted data. Referring to FIG. 10A, the interpretation program 126 may present a validation window 138 that hypothesizes a number of alternate interpretations 140. According to an embodiment of the present invention, a user is provided with up to five hypothesized field values, and is also given the option of selecting a custom value 142 if none of the hypothesized values are correct. The interpretation and validation may also require a positive confirmation on certain fields if a particular application contains a field that is critical. For example, a user must confirm at confirmation box 144 whether value DATA 7 is correct before continuing the program. The forced positive user acts required to validate the form may deter cursory examination by an inattentive user of the system. However, business rules will typically determine whether the interpreted fields should be automatically verified, or whether positive user interaction is required.

Another example of a validation window is illustrated in FIG. 10B. The validation window 146, like the validation window 138 illustrated in FIG. 10A, allows an authorized user to edit the values of interpreted or recognized results. The validation window 146 illustrates the digitally recorded representation of the field currently being examined in handwriting box 148. A number of alternate interpretations 140 are presented, and a custom value 142 is available if the user does not find the proper value of the field in the alternate interpretations box. Navigation controls 150 allow the user to move between fields on the form and information window 152 provides information such the digital form name, trial name, field name and field type.

The computer then saves to the data repository, the original data file, the first pass computer generated interpretation of the data file (where appropriate), the corrected file, and the validation file. As such, a robust auditing path is preserved for downstream processing. Also, a second copy of each data file may optionally be stored in the data repository in a non-modifiable file format, such as a .tif or .pdf formatted file. Further, preserving the data file facilitates the creation of a database of samples useful for regression testing and testing with alternate interpretation software. The various files may be stored for example, in a database as a record associated with the indicator. The various files may also be shared with other information systems. The web viewer may also support the examination of the interpreted and validated data files by the appropriately authorized users. That is, the author of the data file is not always the appropriate person to validate the interpretations. As such, the system 100 may provide various levels of user accessibility and interaction with the various components of the system.

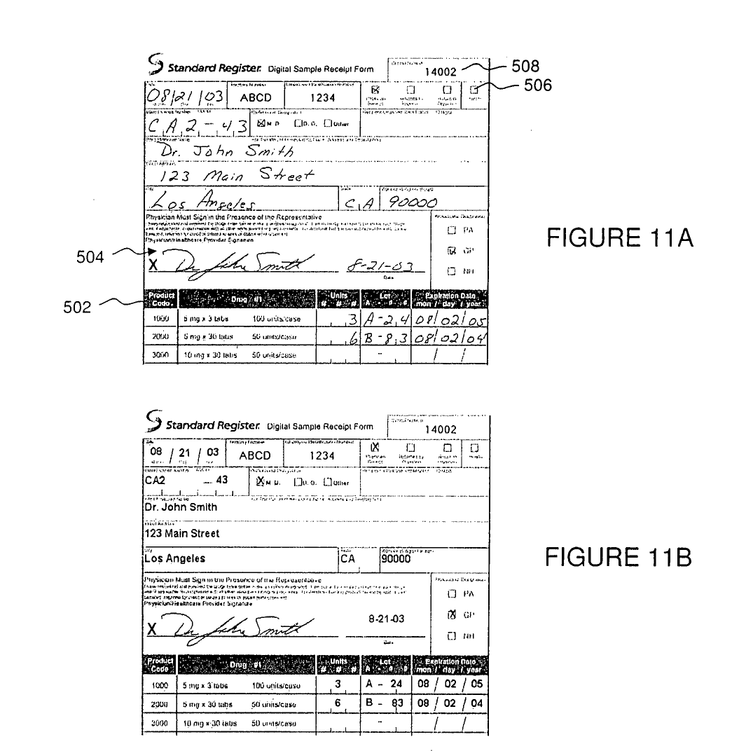

Moreover, the system has now successfully extracted the handwritten information into computer recognizable meaningful digital format that can be used to populate a database as well as perform other downstream workflow functions. Images of the digital forms can be generated showing either the original digital representation of handwritten information recorded by the digital input devices, or a version of the digital form where the representations of the handwritten information is replaced by computer recognized text as shown in FIGS. 11A and 11B. Still further, the system can be selective in which fields are displayed as computer text and which fields remain as digital representations of the handwritten data when rendering images of the digital form. For example, a particular application may provide an image of a digital form where certain fields, such as a signature field, remain as a representation of the handwritten information and other fields are converted to computer text. An example of such an arrangement is shown in FIG. 11B.

### Accessing Data Related to the Instance of a Digital Form

When the interpretation and validation processes are initiated, such as at 208 of FIG. 7, the system fetches all of the relevant information that can be ascertained. For example, as described more fully herein, the unique identifier associated with an instance of a digital form can be found by matching any coordinate read from a particular data file with the range of coordinates bound by a given identifier. There are other ways to find the corresponding additional data, however. For example, there are some applications where many instances of a form will be written upon by the same digital pen. For example, a doctor may use the same digital pen to sign for samples of drugs on a digital Sample Receipt Form, as illustrated in FIGS. 11A and 11B. Each digital pen can be uniquely identified. As such, the computer system can index into the data repository by first filtering against the identifier of the doctor's digital pen. Next, the unique identifier stored with each instance of the form is searched and matched up to the coordinates recorded in the data file. Once the computer matches up the data file to the appropriate instance of the form, any data previously associated with the instance of the form may be used to perform further processing. This approach should result in faster search and retrieval times, especially where a particular company has generated a tremendous volume of digital forms, such as would likely occur with a pharmaceutical sample distribution application as illustrated in FIG. 11.

The example in FIGS. 11A and 11B also illustrates many of the features described more fully herein. For example, as shown in FIG. 11A, the digital form comprises a template 502 that defines the boxes and fields available on the digital form. Various specific types of fields are also displayed. For example, the digital form includes a signature field 504 for receiving the signature of a doctor, and several deterministic fields seen as the check boxes 506. The digital form also includes overlay data 508, which was pulled from one or more data sources and merged with the template. For example, the control code, list and quantity of drugs received, and a host of other information is preprinted onto the digital form.

The examples in FIGS. 11A and 11B also illustrate how the various embodiments of the present invention can be implemented in a drug sample tracking application where a Sample Receipt form is printed on digital paper bearing a position code. With reference to FIG. 11A, a drug representative fills in the “Units Requested,” “Lot” and “Expiration Date” of the Sample Receipt Form using a first digital pen. A doctor then signs and dates the Sample Receipt Form using a second digital pen. This can be carried out in a manner as described more fully herein with reference to FIG. 6. After the appropriate interpretation, recognition and validation programs have run, a second copy of the Sample Receipt Form is created where all of the handwritten information (with the exception of the signature) is converted to computer text.

In another exemplary application, the Patient Linkup® Enterprise system provided by The Standard Register Company of Dayton Ohio is used to link patient information recorded on digital paper with other patient specific information. When a patient is admitted to a hospital, the admission process starts with admitting personnel gathering certain patient information and entering it into the computer. The computer knows which specific forms associated with the care of the patient are required, so those forms are generated and printed out. For example, consent forms, admission forms, insurance forms, nurse's notes, etc. can be printed out, where each form bears a mutually exclusive range of the position code coordinate space. As the forms are filled out with a digital pen, the data is electronically delivered to a computer system at an appropriate host where the data is archived and organized. A doctor assigned to the patient can then log into the computer system and review the complete patient history.

While a pharmaceutical sales rep sample receipt form and a patient lookup form are described herein, such applications should not be construed as limiting the scope of the present invention. Rather, the applications are merely exemplary. Other examples of the vast number of forms that can benefit from the various embodiments of the present invention include sales call reports used by a pharmaceutical sales representative, and booth lead forms used for recording information requests about a conference meeting. It will be appreciated that the systems provided herein can include security features to protect confidential information. For example, symmetric or asymmetric cryptography may be employed at any or all stages of the delivery of digital information from one source to another. Information can be shared across separate networks using Public Key Infrastructure (PKI) or other suitable cryptographic encoding schemes.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

1. A system for digitally processing and interpreting data inputted on a document, the system comprising:
a position code processor to assign a unique position code to said document that is correlated with a form template, wherein said position code processor stores said unique position code, and wherein said position code processor creates a file containing said unique position code;
an output device for receiving said file containing said unique position code and printing as many instances of said document, each with said unique position code printed on a surface of said document as needed;
a digital input device to input information on said surface of said document with said unique printed position code, wherein said digital input device stores digitally said inputted information and the position of said inputted information along with a unique identifier, and wherein said digital input device transfers said inputted information; and
a receiving processor for receiving said inputted information from said digital input device, wherein said receiving processor saves said inputted information into a data file, wherein said receiving processor correlates said data file to said unique position code contained on a specific instance of said document, placing said inputted information in fields of said form template, and wherein said receiving processor interprets and validates said inputted information.

2. The system of claim 1, wherein said output device comprises one of an attached printer, a LAN printer, a WAN printer, and a commercial printer, or combinations thereof.

3. The system of claim 1, wherein said digital input device comprises a digital pen.

4. The system of claim 1, further comprising a tablet PC for supplying information to said receiving processor.

5. The system of claim 1, further comprising a wireless device for supplying information to said receiving processor.

6. The system of claim 1, wherein more than one digital input device is used.

7. The system of claim 1, wherein said digital input device transfers inputted information via one of a service provider, a LAN, a WAN, wireless protocol, cellular protocol, and the Internet, or via combinations thereof.

8. The system of claim 1 wherein said data file contains said inputted information obtained from the digital input device to be used following correlation to determine and implement appropriate workflow.

9. The system of claim 8, wherein said workflow comprises one of pushing and pulling upstream or downstream systems with data, populating databases, sending emails with said digital information, sending email reminders, and indexing images and related data from subsequent lookup, or combinations thereof.

10. The system of claim 1, wherein said position code processor and said receiving processor are resident on the same processor

11. The system of claim 1, further comprising:
a display to show an interpretation of said digital written information for validation; and
a display input to confirm and edit the interpretation of said inputted information.

12. The system of claim 11, wherein said display is remote from said receiving processor.

13. The system of claim 11, wherein said display input is remote from said receiving processor.

14. The system of claim 1, wherein said document comprises a form.

15. A system of producing custom digital documents, the system comprising:
a first server providing a digital layout of a digital document, wherein said first server saves for later retrieval said digital layout of said digital document in a printable format;
a second server providing a unique position coded pattern to be merged with said digital layout of digital document from said first server, wherein said second server stores said unique position coded pattern assigned to said digital layout of each unique instance of said digital document with a unique identifier for later retrieval; and
an output device to print as many unique instances of said resulting digital document produced by said second server as needed.

16. The system of claim 15, further comprising:
a digital document definition tool to produce a digital layout of a digital document by combining a layout of a form template with a variable overlay.

17. The system of claim 16, wherein said digital layout of a digital document further comprises:
fields, text, graphics and indicia required by said form template.

18. The system of claim 17, wherein said fields further comprise user-designated fields.

19. The system of claim 18, wherein said user-designated fields comprises one of signature fields, handwritten input fields, symbol fields, handwritten scrawls, and graphics fields, or combinations thereof.

20. The system of claim 16, wherein said variable overlay further comprises:
variable data comprises one of demographic data from a database, personal data from a database, sequential control numbers, and date and time stamps, or combinations thereof.

21. The system of claim 15, wherein said first server further comprises:
a general software program providing a digital layout of said digital document.

22. The system of claim 21, wherein said general software program comprises one of Microsoft Word, Word Perfect, Microsoft Excel, Microsoft Power Point slides, Abode PageMaker, and engineering CAD/CAM files, or combinations thereof.

23. The system of claim 15, wherein said first server and said second server are resident on the same processor.

24. The system of claim 15, wherein said custom digital documents comprise forms.

25. A system for capturing information recorded on a digital document, the system comprising:
a digital input device to record position coded pattern data of input entered on said digital document; and
a processor to receive recorded position coded pattern data from said digital input device along with an identifier of said digital input device, wherein said processor transfers said recorded position coded pattern data to a data file, and wherein said processor correlates and positions said recorded position coded pattern data into representative digital data associated with a unique instance of said digital document.

26. The system of claim 25, wherein said digital document comprises a form.

27. A method for capturing and processing information captured on a unique digital document, comprising the steps of:
creating said unique digital document;
assigning a unique position code to a surface of said unique digital document;
outputting as many instances of said unique digital document as needed, each with a unique position code;
capturing data inputted on said surface of said unique digital document from at least one digital input device;
transferring said data from said at least one digital input device to a processor along with an identifier for each digital input device;
storing by said processor of said data from said at least one digital input device to a data file with said identifier;
correlating said data to the unique instance of said digital document;
interpreting said data file;
recording a separate file of an interpretation of said data file;
validating interpretation of said data file and creating a separate validated interpretation of said data file; and
saving said validated interpretation of said data file and all associated files of said data from said at least one digital input device.

28. The method of claim 27, wherein the step of creating further comprises the step of:
combining a digital layout of a form template with a variable data overlay.

29. The method of claim 27, wherein the step of creating said unique digital document includes the step of creating said digital document by using general software.

30. The method of claim 27, wherein the step of storing comprises the step of:
recording creation times of said data of each individual digital input device.

31. The method of claim 27, wherein the step of interpreting comprises the steps of:
obtaining said unique digital document based on said identifier;
transforming said data from said at least one digital input device from said input data file into a digital data interpretation; and
storing a digital data interpretation.

32. The method of claim 31, wherein the step of transforming comprises the step of:
running a character recognition software against said input data file.

33. The method of claim 31, wherein the step of transforming comprises the step of:
recognizing any signature fields of said unique digital document and analyzing said signature fields for authenticity.

34. The method of claim 27, wherein the step of validating comprises the steps of:
obtaining said interpretation of said data file;
displaying interpretation of said data file;
confirming said interpretation of said data file data if a datum of said data file data is required;
editing said interpretation of any misinterpreted data file data; and
storing validated interpretation of said data file.

35. The method of claim 34, wherein the step of editing is based on the authorization level of the user accessing said data.

36. The method of claim 34, wherein the step of editing comprises the step of listing the highest probable interpretation of said data in order of confidence of the interpretation.

37. The method of claim 34, wherein the step of editing comprises the step of spell checking.

38. The method of claim 27, wherein the step of validating is performed remotely over the Internet.

39. The method of claim 27, wherein the step of validating is performed with tablet PC.

40. The method of claim 27, wherein the step of validating is performed with wireless device.

41. The method of claim 27, wherein the step of validating is performed by more than one user.

42. The method of claim 41, wherein the performance by more than one user is conducted remotely.

43. The method of claim 41, wherein the performance by more than one user is conducted at different times.

44. The method of claim 27, further comprising the step of:
using validated interpretation of said data file to populate databases and to feed workflow and backend processes.

45. The method of claim 27, further comprising the step of:
outputting said validated interpretation of said data file to an output display.

46. The method of claim 27, wherein said unique digital document comprises a form.

47. A method for producing print on demand digital documents, the method comprising the steps of:
combining a digital layout of a form template with a variable data overlay to produce a unique digital document;
merging said digital document with a unique position coded pattern to produce an instance of said digital document; and
outputting as many instances of said digital document as needed, each instance having a unique position coded pattern.

48. The method of claim 47, wherein said digital document comprises a form.

49. A method for capturing information recorded on a unique digital document, the method comprising the steps of:
recording data inputted onto a unique digital document by a digital input device, wherein said input device has an identifier;
transferring said data inputted by said digital input device along with said identifier of said digital input device to a processor;
correlating said data with the unique digital document and determining the positions on said digital document represented by said data; and
saving said data and said identifier to a data file.

50. The method of claim 49, wherein the step of recording comprises the step of recording data from more than one digital input device, each digital input device having an identifier.

51. The method of claim 49, wherein the step of transferring comprises the step of using wireless technology to transfer data from said digital input device to said processor.

52. The method of claim 49, wherein the step of transferring comprises the step of docking said digital input device to a docking station to transfer data from said digital input device to said processor.

53. The method of claim 49, wherein the step of transferring comprises the step of connecting said digital input device to said processor by a wired connection.

54. The method of claim 49, wherein the step of transferring comprises the step of transferring said data from more than one digital input device to said processor along with said identifier of each digital input device.

55. The method of claim 49, wherein the step of saving comprises the step of saving transferred data to a data file from more than one digital input device.

56. The method of claim 49, wherein the step of correlating comprises the step of correlating saved data files from more than one digital input device into representative digital data of a single digital form.

57. The method of claim 49, wherein said unique digital document comprises a form.
